(19) United States
(12) Patent Application Publication
(10) Pub. No.: US 2016/0231101 A1
(43) Pub. Date: Aug. 11, 2016

(54) SWEPT-SOURCE OPTICAL COHERENCE TOMOGRAPHY (SS-OCT) SYSTEM WITH SILICON PHOTONIC SIGNAL PROCESSING ELEMENT HAVING MATCHED PATH LENGTHS

(71) Applicant: Eric SWANSON, GLOUCESTER, MA (US)

(72) Inventor: Eric SWANSON, GLOUCESTER, MA (US)

(21) Appl. No.: 15/018,791

(22) Filed: Feb. 8, 2016

Related U.S. Application Data
(60) Provisional application No. 62/113,353, filed on Feb. 6, 2015.

(51) Int. Cl. G01B 9/02

(52) U.S. Cl. CPC G01B 9/02091

(57) ABSTRACT

Aspects of the present disclosure are directed to architectures, methods and systems and structures having application to an interferometric optical system such as a swept-source optical coherence tomography (SS-OCT) system including an optical processing element having dual-polarization and dual-balanced in-phase and quadrature processing and photodetection paths on a single integrated photonic chip wherein lengths of the paths are less than or equal to the spatial resolution of a laser source.

### CROSS REFERENCE TO RELATED APPLICATIONS

This application claims the benefit of U.S. Provisional Patent Application Ser. No. 62/113,353 filed Feb. 6, 2015 the entire contents of which is incorporated by reference as if set forth at length herein.

### TECHNICAL FIELD

This disclosure relates generally to interferometric optical systems useful—for example—in imaging, ranging, sensing, instrumentation, and other applications such as swept-source optical coherence tomography (OCT) systems.

### BACKGROUND

Contemporary interferometric optical systems oftentimes detect only a single polarization and a single quadrant of a signal light which unfortunately results in a suboptimal signal-to-noise ratio, image artifacts, reduced measurement range and loss of information with respect to optical properties of a sample being measured.

### SUMMARY

The above problems are solved and an advance is made in the art according to an aspect of the present disclosure directed to a swept-source optical coherence tomography (SS-OCT) system.

More particularly, and in sharp contrast to certain contemporary systems which oftentimes exhibit suboptimal signal-to-noise, image artifacts, reduced measurement range and loss of information with respect to optical properties of a sample being measured, systems according to the present disclosure employ a silicon photonic optical processing element having matched path lengths wherein the lengths of the paths are less than or equal to the spatial resolution of the laser

This SUMMARY is provided to briefly identify some aspects of the present disclosure that are further described below in the DESCRIPTION. This SUMMARY is not intended to identify key or essential features of the present disclosure nor is it intended to limit the scope of any claims.

The term “aspects” is to be read as “at least one aspect”. The aspects described above and other aspects of the present disclosure described herein are illustrated by way of example(s) and not limited in the accompanying drawing.

### BRIEF DESCRIPTION OF THE DRAWING

A more complete understanding of the present disclosure may be realized by reference to the accompanying drawing in which:

FIG. 1 shows schematic diagram depicting a swept source OCT system;

FIG. 2 shows illustrative 1D, 2D, and 3D imaging produced from a series of axial scans according to an aspect of the present disclosure;

FIG. 3 shows a schematic block diagram depicting a system having a single-polarization, non UQ, dual-balanced receiver according ton an aspect of the present disclosure;

FIG. 4 shows a schematic block diagram depicting an exemplary system having circulators and dual polarization receiver with a polarization splitter and 90 degree hybrids exhibiting I and Q channels in two polarizations according to an aspect of the present disclosure;

FIG. 5 shows a schematic block diagram depicting illustrative dual balanced receiver configurations according to an aspect of the present disclosure wherein a) shows two photo-diodes directly connected to a trans-impedence amplifier (TIA); b) shows two photo-diodes connected to separate inputs to a differential TIA; and c) shows two photodiodes connected to separate TIAs wherein output of the TIAs are input into a differential amplifier; and

FIG. 6 shows exemplary signal processing of a dual polarization 1/Q received signal according to an aspect of the present disclosure.

The illustrative embodiments are described more fully by the Figures and detailed description. The inventions may, however, be embodied in various forms and are not limited to specific embodiments described in the Figures and detailed description

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

The functions of the various elements shown in the Figures, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the FIGURES are not drawn to scale.

We now provide some non-limiting, illustrative examples that illustrate several operational aspects of various arrangements and alternative embodiments of the present disclosure.

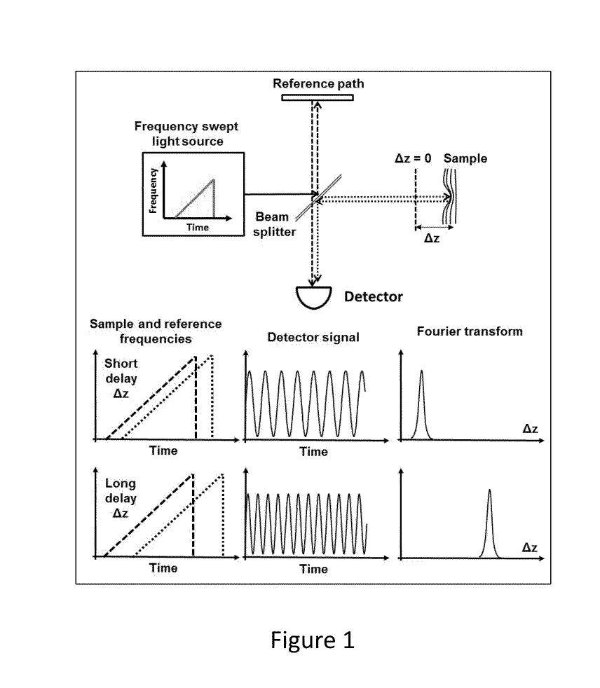

Turning now to FIG. 1 there is shown a schematic of an illustrative example of an axial imaging component of an optical coherence tomography arrangement including a swept-source according to an aspect of the present disclosure. Aspects of that arrangement are generally known in the art and described in U.S. Pat. No. 8,947,648 issued to Swanson et al. on Feb. 3, 2015 the entire contents of which is hereby incorporated by reference as if set forth at length herein. More particularly, and as depicted in that FIG. 1, a frequency swept light source is coupled to a Michelson interferometer which those skilled in the art will readily understand comprises two optical paths or “arms”.

Operationally, a frequency tunable optical source is coupled to the interferometer such that one arm leads to a sample while the other arm leads to a reference reflection. Light reflected from the reference path and the sample are interferometrically combined and directed to a photodetector.

Advantageously, information about longitudinally resolved optical properties of the sample may be obtained by analyzing the photodetected, interferometrically combined signals. In the simplified system shown in FIG. 1, information about the relative delay between the reference path and a reflection within the sample (Δz) and the amplitude of the sample reflection can be obtained by Fourier transform processing the photodetected signal.

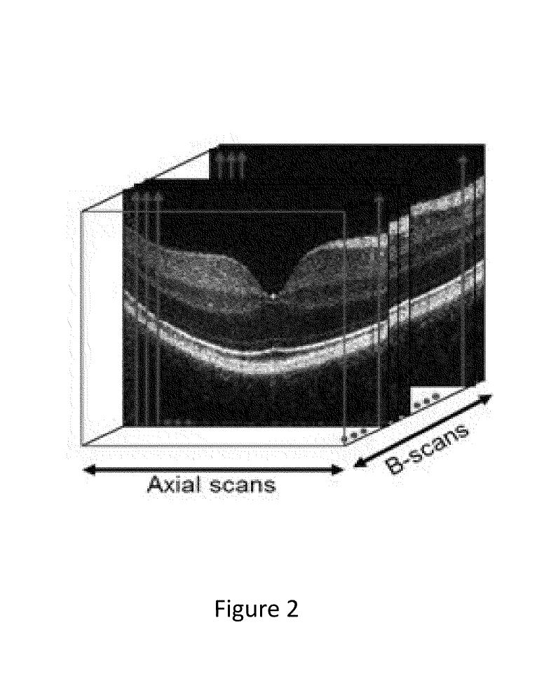

With reference now to FIG. 2, there it shows an illustrative example in schematic form of how 1D, 2D, 3D images may be constructed by combining axial/longitudinal scanning from a laser source frequency sweep and Fourier transform processing along with lateral scanning of light onto a sample via a probe module (not specifically shown) as performed by contemporary systems.

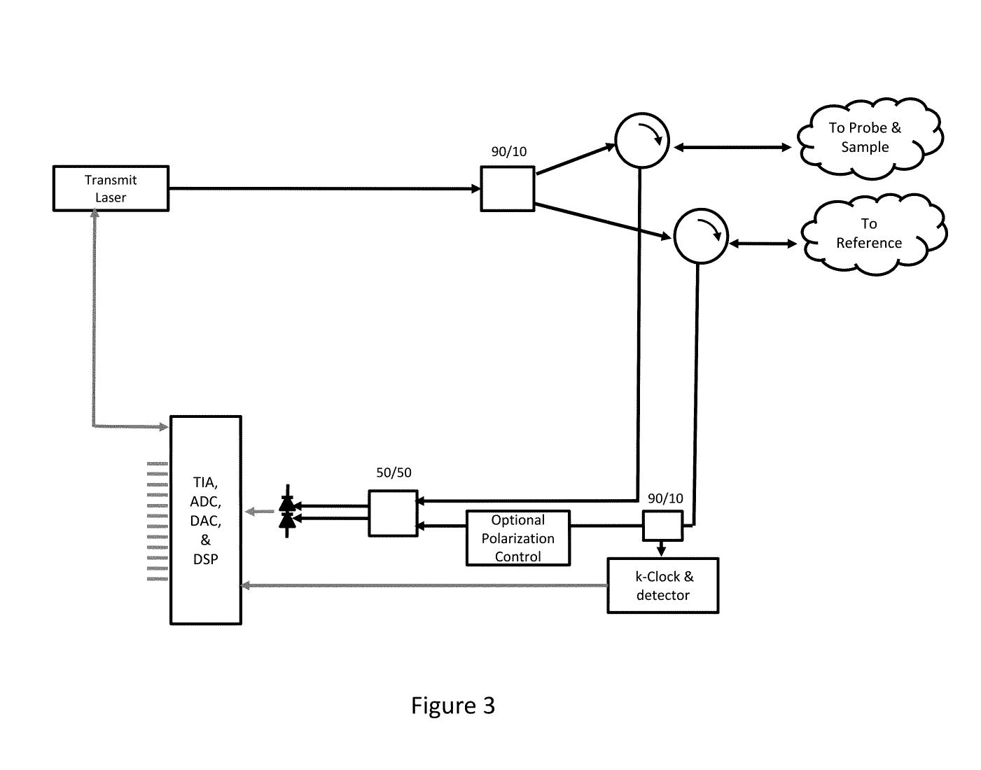

Turning to FIG. 3, there it shows a schematic block diagram of an illustrative SS-OCT system having a single polarization, non-UQ dual-balanced receiver. While the basic concept of this simplified system shown is known in the art it will be briefly reviewed here. As may be observed from FIG. 3, a frequency swept transmitter laser output is split into two outputs through the effect of a 90/10 or other suitable splitter. The split light is directed to two circulators one of which directs light to a probe module that guides light to and from a sample while the other circulator directs light to a reference reflection.

Reflected light from the sample and reference are directed from a third port of their respective circulator(s) to a 50/50 coupler and further onto a dual balanced receiver. Those skilled in the art will appreciate that an optional optical polarization controller may be employed to align the reference and sample arm polarizations to optimize the interferometrically detected signal.

Shown further in FIG. 3 is a 90/10 coupler in the reference path after the reference circulator that directs light to a k-clock system that can advantageously compensate for a non-ideal frequency sweeps of the transmitter laser as is known in the art. There are many other equivalent embodiments of SS-OCT systems that use different types of interferometers, couplers, split ratios, different type of non-reciprocal elements, or no non-reciprocal elements, use of polarization preserving or polarizing fiber as is known.

Among the limitations of SS-OCT systems such as that shown in FIG. 3, is that only one polarization is detected and only one optical quadrature of light is detected from the light altered by interaction and reflection from the sample.

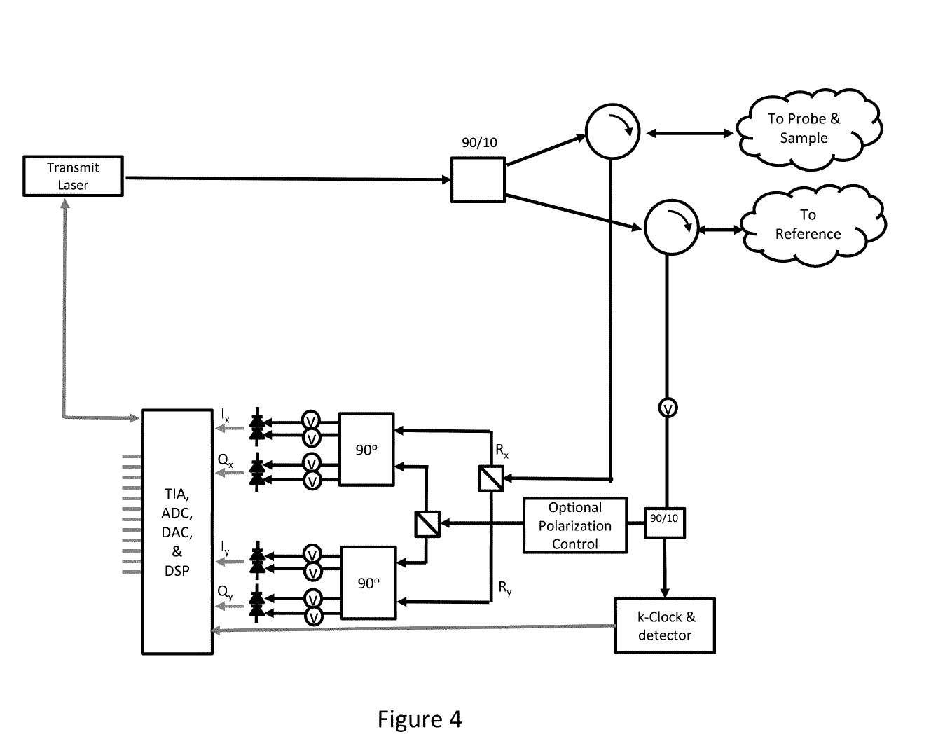

FIG. 4 shows further illustrative extensions where a more complex receive is depicted and includes dual-balanced photodetection, dual-polarization, and UQ detection. In this embodiment shown, light from the sample and reference reflections are directed into polarization splitters and then each polarization is sent into a 90 degree hybrid that outputs interferometrical combined single polarization signals that can be sent into dual-balanced photodetector receivers. As configured, the I-channel contains the in-phase quadrature of sample arm light and the Q-channel contains the out-of-phase quadrature of sample arm light. As will be readily appreciated and understood by those skilled in the art, there are many other equivalent embodiments of the arrangement depicted in FIG. 4 including different types of interferometers, couplers, split ratios, different type of non-reciprocal elements, use of polarization preserving or polarizing fiber as was mentioned previously.

Advantageously, the optical polarization controller can be used as shown in FIG. 4. In one preferred embodiment the reflection from the reference arm is adjusted by the polarization control so that equal reference arm power illuminates each of the polarization channels. The polarization controller can be fixed if the environmental behavior of the reference arm path is stable or it can be adjustable if the behavior of the reference arm polarization can wander over time. A simple feedback loop can be used in the case of an adjustable polarization controller where the feedback signal is related to the difference in the X and Y polarization powers (e.g. from the detected photocurrents).

Also shown in FIG. 4 is the optional use of variable optical attenuators, VOA, (“v” in the FIG. 4) placed at the output of the 90 degree hybrids. The purpose of these variable optical attenuators is to optimize the intensity noise cancellation performance of the dual balanced receivers. If for example the responsivity of the matching photodetectors is not sufficiently matched or other characteristics of the receiver transmission losses (e.g. split ratios, waveguide losses, etc) then the intensity noise cancelling behavior of the dual balanced receivers will be compromised. By placing variable optical attenuators in the paths as shown, then this differential loss can be calibrated out during manufacturing, or during operation, so as to achieve good intensity noise cancellation performance.

One simple method to adjust the VOAs is to place an intensity modulated signal into the reference arm and adjust one or both of the VOAs until that signal is nulled. In addition, it is possible to place a VOA in the reference path. This VOA can be used for multiple functions including setting the nominal reference arm power and to temporarily impart an intensity modulated signal for matching the dual balanced receiver intensity noise cancellation performance.

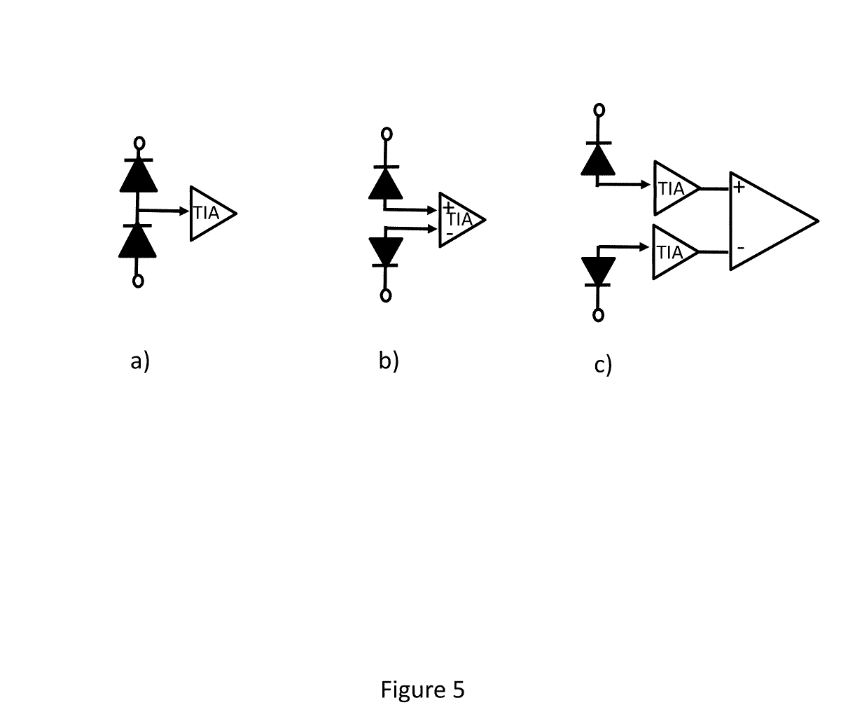

Turning now to FIG. 5, there it shows different illustrative example configurations of dual balanced receivers. FIG. 5a) shows two photo-diodes connected directly to a TIA. FIG. 5b) shows two photo diodes connected to separate inputs to a differential TIA, and FIG. 5c) shows two photodiodes connected to separate TIAs the output of the TIAs going into a differential amplifier. An alternative to using the optical VOAs shown previously in FIG. 4, is to adjust the differential electrical gains in FIG. 5b and FIG. 5c.

As noted previously, many OCT systems detect one polarization of light while employing a system such as that shown in FIG. 3. Since light reflected from the sample can scatter into the orthogonal polarization (either because of the samples birefringence or artifacts induced by the probe (e.g. a spinning optical probe) the resulting image produced can suffer from loss of signal. In such circumstances, often measurements or images of a sample are produced that have signal fades when the light is mostly reflected into the orthogonal polarization. This can cause confusion in the data as it is unclear if a true optical property of the sample is being measured or an artifact of the system configuration and its inability to measure both polarizations at once.

Certain OCT systems do detect two polarizations of light and process the two outputs to produce an image that is mostly independent of the state of reflected light polarization. Other OCT systems perform more complex processing functions to determine the spatially resolved birefringence properties of the sample. This is often referred to as polarization sensitive OCT (PS-OCT).

However even if both polarizations are detected, most receiver structures do not simultaneously detect both quadratures of the reflected light. There can be signal artifacts due to detection of just one quadrature of light and is somewhat analogous to detecting only one component of the polarization.

Advantageously, the receiver structure shown in FIG. 4 allows detection of both polarizations and both quadratures of light for a total of four output signals. More particularly, the four output signals are Ix, Qx, Iy, Qy, where Ix is the in-phase quadrature of light in the x-polarization, Qx is the out-of-phase quadrature of light in the x-polarization and where ly is the in-phase quadrature of light in the y-polarization, Qy is the out-of-phase quadrature of light in the y-polarization.

As may be readily appreciated by those skilled in the art, there are many signal processing possibilities of these four outputs and many receiver topologies that can produce these four outputs and the arrangement depicted in FIG. 4 is just one illustrative example of receiver topology and the processing steps below are just a few examples of signal processing possibilities. Further some of the processing steps below can be performed on a non-dual-polarization but with I/Q reception and some can be performed on a non-I/Q but with dual polarization reception.

One example of a signal processing step for a dual balanced, dual polarization, I/Q receiver is to simultaneously detect the sum of the squares (or a similar equally weighted metric) of the four components as shown in Equations 1-3 below.

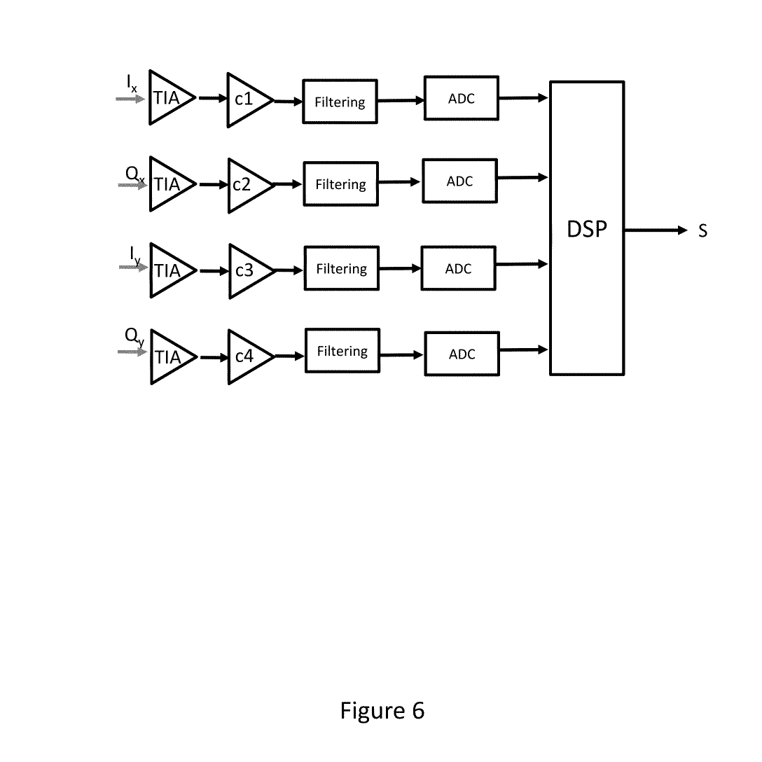

FIG. 6 shows a conceptual signal processing chain according to an aspect of the present disclosure. Where TIA is a transimpediance amplifier stage (or other photodetector termination stage to convert photocurrent to a voltage), C1, C2, C3, and C4 are multiplicative coefficients (e.g. from a fixed, automatic or adjustable gain control stage) that can be used to adjust weightings, for example, to compensation for variations in gain along the four electro-optical paths (e.g. difference in photodetector responsively or TIA gain). There is optional signal filtering and other processing that can be performed as is known in the art, for example to eliminate out of band noise or aliasing of signals. The output of this filter is directed to a high speed analog to digital converter (ADC). The output of the four ADCs is directed to a digital signal processing (DSP) module. Note the configuration shown in FIG. 6 is just one possible embodiment and those skilled in the art will appreciate that equivalent methods—for example—such as one having 8 TIAs—one for each photodetector—that perform dual balancing function(s) in a differential voltage amplifier (e.g. FIG. 5c), or perform the processing in the analog domain or otherwise alter some of the orders of the processing steps shown in FIG. 6.

Some examples of signal processing steps that can be used include:

S=[(c1Ix̂2+c2Qx̂2)+(c3Iŷ2+c4Qŷ2)] (Equation 1)

S=sqrt[(c1Ix̂2+c2Qx̂2)+(c3Iŷ2+c4Qŷ2)] (Equation 2)

S=log[(c1Ix̂2+c2Qx̂2)+(c3Iŷ2+c4Qŷ2)] (Equation 3)

where sqrt stands for a square root operation and log stands for a logarithm operation.

As may be readily understood, Equation 1 combines a linear weighting of the electrical powers of the four channels. Equation 2 is the square root operation on a linear weighting of the electrical powers of the four channels, and Equation 3 is a log operation on a linear weighting of the electrical powers of the four channels. Displaying log magnitudes is often attractive for some high dynamic range signals and images.

One aspect of the above calculations is to allow either equal power weightings of the four components so that a near constant level of light is detected for a reflection from the sample independent of which polarization or which optical quadrature the light is detected in at the receiver. The coefficients C1-C4 can be obtained with numerous calibration methods. For example during manufacturing the signal path from the polarization splitter inputs to each of the 8 output channels can be measured by sweeping the polarization angle and optical phase and the peak signal measured. Another method is to first ensure that there is equal reference arm power illuminating each of the X and Y polarization channels by using the polarization controller or other suitable means. Then in the sample arm use a calibrated test target that illuminates both polarizations and both optical quadrature's of light equally (either simultaneously or by sequentially altering the calibration test target over time). Initially the coefficients C are set to the same value. By recording the maximum outputs in each of the 4 channels shown in FIG. 6, a relative weighting can be determined to ensure each channel responds equally.

At this point it is noted that for a non-dual-polarization, I/Q enabled receiver the processing could be similar—however for just a single I/Q channel. Note further that for many applications of biomedical imaging and NDENDT systems it is important to measure a samples birefringence. There are many approaches as is known in the art for SS-OCT systems to measure sample birefringence including alternating the polarization state on consecutive frequency sweeps or alternating the state of polarization intra-sweep. Notably, an extension is to detect both I and Q phases and perform similar process steps for birefringence measurements. For example if a functional processing step (or steps) involves just one quadrature such as given below in Equation 4:

S=Function[Ix, Iy] (Equation 4)

then an improved alternate embodiment of that functional processing step can be modified and improved by an equal amplitude or power weighting on the individual I and Q signals as shown below in Equation 5.

S=Function[sqrt(c1Ix̂2+c2Qx̂2), sqrt(c3Iŷ2+c4Qŷ2)] (Equation 5)

As described above, the concept is to simultaneously detect both quadratures of light and combine them before processing to extract birefringence information.

In many SS-OCT systems that do not involve I/Q processing, a non-zero delay or offset between the sample arm reflection and the reference reflection is utilized to prevent aliasing of the image. For example, sample reflections that are 1 mm longer than the reference path length can show up at the same beat frequency as a sample reflection that is 1 mm shorter than the reference path length. Therefore, such SS-OCT systems operate with an offset between the sample arm measurement region of interest and the reference arm. That way all significant sample arm reflections show up at a positive frequency and there is no image aliasing.

One disadvantage of this arrangement is that the swept laser source has a finite coherence length and operating with the sample arm to reference arm offset requires roughly a factor of two increase in laser source coherence length for a given desired measurement range. Another disadvantage of this arrangement is that the beat frequencies are roughly a factor of two higher requiring faster TIAs and ADCs.

Those skilled in the art will understand that an I/Q processor can operate at zero relative delay between the sample and reference arm and apply appropriate signal processing to eliminate the image aliasing. What is not possible however is the ability to operate with zero delay using the appropriate I/Q processing while simultaneously obtaining dual-polarization information. Advantageously, the receiver structure according to the present disclosure and depicted in FIG. 4 provides for or that operation.

Those skilled in the art will readily appreciate that there are numerous embodiments contemplated to construct the optical receiver structure of FIG. 4. These include integration of bulk optical devices, miniature optical hybrid approaches, and photonic integrated circuits. Photonic integrated circuits, including silicon photonics, is a particularly attractive method for constructing the receiver shown in that FIG. 4 (and similar technologies) as silicon photonic integrated circuits (PICS) may be manufactured in high volume, at low costs, good yields, exhibit minimal temperature sensitivity, and packaged such that they exhibit a small volume and weight.

For operation in a 1310 nm region, standard silicon photonic substrates are preferred in one embodiment while for operation in a 1060 nm region, silicon nitride substrates offer advantages of lower loss. Structures such as those shown in FIG. 4 have been demonstrated at 1550 nm in a fiber optic telecommunication context as described [See, e.g., M.Izutsu, S.Shikama, and T.Sueta, “Integrated Optical SSB Modulator/Frequency Shifter,” IEEE J.Quant. Electron., vol. 2, no. 11, pp.2225-2227, 1981].

One important design and/or processing consideration for optimal performance of the SS-OCT receiver structure such as that shown in a portion of FIG. 4 is to address the potential different delays in the four paths from the reference port input of the receiver to the in-phase and quadrature components of each polarization (Ix, Qx, Iy, Qy) and the four paths from the sample arm input of the receiver to in-phase and quadrature components of each polarization (Ix, Qx, Iy, Qy). In order to perform optimal processing for applications such as high resolution imaging, complex-conjugate suppressed full-range OCT, polarization diversity detection, and polarization-sensitive OCT the delays need to be matched to less than the longitudinal spatial resolution of the laser sources (sometimes called the coherence length) or be processed out digitally in a post processing step.

A preferred embodiment of a receiver according to the present disclosure is one fabricated as a photonic integrated circuit (PIC), preferably in InP, GaAs, Silicon, or Silicon Nitride. A silicon photonic PIC is particularly attractive as it uses mature high volume foundry processing techniques and operates well at 1.3 um wavelengths. In designing the PIC, layout tools may be employed in order to match each of the various path lengths mentioned to less than the resolution or coherence length of the source. Alternatively, or in addition, the optical path lengths can easily be measured by using, for example, a mirror reflection in the sample arm and the probe arm and measuring the axial SS-OCT scan. If all four channels are not sufficiently aligned then the delays are measured by digitizing and recording the longitudinal traces of each channel and comparing the peaks in reflections due to the mirror surface and measuring the distance between those peaks and then using that distance offset in subsequent measurements.

At this point, while we have presented this disclosure using some specific examples, those skilled in the art will recognize that our teachings are not so limited. Accordingly, this disclosure should be only limited by the scope of the claims attached hereto.

1. An interferometric optical system comprising:
a laser configured such that a portion of light output from the laser is directed to a sample and a portion of the light output from the laser is directed to a reference;
a receiver for interferometrically combining light altered by the sample and light altered by the reference, said receiver including:
an optical processing element having dual-polarization and dual-balanced in-phase and quadrature processing and photodetection paths on a single integrated photonic chip;
wherein lengths of the paths are less than or equal to the spatial resolution of the laser.

2. The interferometric optical system of claim 1 wherein the laser is configured such that light output from the laser varies over time.

3. The interferometric optical system of claim 1 wherein said receiver includes an electronic processor.

4. The interferometric optical system of claim 3 configured to operate as part of a swept source optical coherence tomography (SS-OCT) system.

5. An interferometric optical system comprising:
a laser configured such that a portion of light output from the laser is directed to a sample and a portion of the light output from the laser is directed to a reference;
a receiver for interferometrically combining light altered by the sample and light altered by the reference, said receiver including:
an optical processing element having dual-polarization and dual-balanced in-phase and quadrature processing and photodetection paths on a single integrated photonic chip; and
electrical processing elements in which any length differences between the paths are stored and used to electronically compensate so as to align the lengths of the paths to less than the laser coherence length.

6. The interferometric optical system of claim 5 wherein the laser is configured such that light output from the laser varies over time.

7. The interferometric optical system of claim 6 configured to operate as part of a swept source optical coherence tomography (SS-OCT) system.
